(19) United States
(12) Patent Application Publication
(10) Pub. No.: US 2025/0282045 A1
(43) Pub. Date: Sep. 11, 2025

(54) REMOTE CONTROL JOBSITE MATERIAL STAND

(71) Applicant: Gary Wayne Marston, III, Buckfield, ME (US)

(72) Inventor: Gary Wayne Marston, III, Buckfield, ME (US)

(21) Appl. No.: 18/795,220

(22) Filed: Aug. 6, 2024

Related U.S. Application Data
(60) Provisional application No. 63/563,379, filed on Mar. 10, 2024.

(51) Int. Cl. B25H 1/16; B25H 1/06

(52) U.S. Cl. CPC B25H 1/16; B25H 1/06

(57) ABSTRACT

One aspect of the disclosure is for a remote-controlled apparatus (110) used to support, lift, lower, and move side to side lumber and other materials in a variety of applications including but not limited to cutting, assembling, or installing. The apparatus (110) can include four folding adjustable legs, a telescopic vertical main shaft, and a horizontal top rail (see FIG. 2A, for example). Inside the main shaft is an electronic actuator to provide vertical linear movement. The top rail is equipped with a motor and ball screw to provide horizontal linear movement.

### CROSS-REFERENCE TO RELATED APPLICATIONS

The present application claims priority under 35 USC 119(e) to U.S. Provisional Application No. 63/563,379 filed Mar. 10, 2024, the entire contents of which is incorporated by reference.

### FIELD OF THE EMBODIMENTS

The field of the invention and its embodiments relates to building trades, adjustable sawhorses, work tables, material stands, and/or other supports (trestle/scaffold) for cutting materials, and more specifically to a remote control jobsite material stand.

### BACKGROUND OF THE EMBODIMENTS

In woodworking and construction, a saw-horse or sawhorse (saw-buck, trestle, buck) is a trestle structure used to support a board or plank for sawing. A pair of sawhorses can support a plank, forming a scaffold. A scaffold can be a temporary platform used to elevate materials during construction, repair, or cleaning of a structure or machine. Commonly plywood, planks, two-by-fours, and other components to be worked/cut with a saw are placed on such a scaffolding. While these components are often planar and rectangular (e.g., plywood), they can also be curved or other non-uniform shapes. Often a saw or other tool will pass through the plywood when supported by two sawhorses, which necessitates a void existing between two supports.

Accidents and mishaps are common when using scaffolds, such as sets of sawhorses, improperly. A more severe one of the common mishaps includes wounds resulting from improper contact of a body part with an active saw. Other mishaps occur when a load, which is placed on a scaffold, shifts. Cutting a supported plank/panel that was originally supported by two sawhorses, inherently (and quickly) shifts a supported load. Heavy components, such as thick planks are often partially supported by a sawhorse and partially supported manually during a cutting process (to prevent load shifting when cut). Further, loads shift when components are moved on/off the sawhorse(s). Problems with load shifts are exasperated when using sawhorses on an uneven surface, with uneven legs, with uneven telescoping surfaces, or when using adjustable sawhorses that have been improperly adjusted/positioned. Although adjustable sawhorses exist, they sometimes aggravate safety concerns, especially when improperly used. Further, conventional adjustable sawhorses are not designed to be adjusted under load, which exacerbates safety concerns.

In one example, a miter saw is a common tool found on most jobsites. It is used to cut a variety of building materials at different bevels and angles. To cut long material with a miter saw it is required that the material is supported at one end allowing the other end to sit flat on the saw. If the material being cut is not sitting flat and against the fence, the angle of the cut will be wrong. It could also bind the blade of the saw and become dangerous. This same concept can be applied to cutting with a table saw. Not all lumber or building material will sit flat on the saw with one setup. This causes the height at which the material is supported to frequently change. Making these adjustments can be difficult, time-consuming, or use valuable materials.

Traditionally, support for the material being cut was achieved by building sawhorses out of wood, using metal folding sawhorses, or using a miter saw stand with horizontal support arms. A wood sawhorse is limited to the height at which it was built and does not have adjustments. Some metal folding sawhorses have adjustable legs but do not have the ability to make micro adjustments. It can also be difficult and dangerous to adjust the legs once there is a load on the sawhorse. Miter saw stands are limited to the length at which the support arms extend. Making it unusable for long material. Also, the further the arm is extended the more deflection there is when a load is applied. Causing the operator to make multiple adjustments.

What is needed is a load supporting structure, whether sawhorse, worktable, etc., that is able to be safely and conveniently adjusted under load, without sacrificing key sawhorse advantages of ease-of-use, portability, and the like that have resulted in sawhorses' prevalent use.

### RELATED ART

WO2021/035371 pertains to a modular support for holding up work or supporting surfaces, such as tables, counters, drawing boards, banquet tables or similar furniture, wherein the support allows the height and slope of the support surface to be adjusted.

WO2017/009844 pertains to a height adjustable sawhorse.

U.S. Pat. No. 6,701,853 pertains to tables having a tabletop whose height is adjustable. The table is useful among other employments as a coffee table whose height can be varied to suit the needs of persons using the table for various purposes, including game playing.

U.S. Pat. No. 5,865,269 pertains to a work support device with adjustable length legs used to stabilize the work support on an uneven bearing surface, that is height adjustable.

U.S. Pat. No. 5,560,449 pertains to an adjustable sawhorse for contemporaneously adjusting both the height and angle of inclination of the support member.

U.S. Pat. No. 5,402,860 pertains to a sawhorse formed of rectangular metal tubes and “I” beams that are attached to and contained within a main beam.

### SUMMARY OF THE EMBODIMENTS

Embodiments of the present invention solve real-world experienced and unresolved problems by providing a stand, trestle, scaffolding (e.g., adjustable support 110) that can be adjusted by remote control (e.g., controller 160) while a load (resulting from a force of gravity applied while supporting component 154) is applied. The stand/support (110) can lift, lower, and move material left or right. In embodiments, the stand/support (110) can be angled. A user can make large or micro adjustments by remote (via controller 160) without having to leave the saw (e.g., tool 150) or workstation. This allows the user to align the material (154) fast and easily, creating safer and more accurate cuts.

One aspect of the disclosure is for a remote-controlled apparatus (110) used to support, lift, lower, and move side to side lumber and other materials in a variety of applications including but not limited to cutting, assembling, or installing. The apparatus (110) can include four folding adjustable legs, a telescopic vertical main shaft, and a horizontal top rail (see FIG. 2A, for example). Inside the main shaft is an electronic actuator to provide vertical linear movement. The top rail is equipped with a motor and ball screw to provide horizontal linear movement.

Another aspect of the disclosure includes a remotely adjustable scaffold for supporting materials to be cut. The scaffold includes a first adjustable trestle and a second adjustable trestle. In aggregate, the first adjustable trestle and the second adjustable trestle are referred to as trestles. Each of the trestles is a portable structure configured to be rapidly repositioned by a human within a work site. Each of the trestles is physically, mechanically, and electronically independent of the other one of the trestles. The trestles are configured to support a load of the materials extending across the top plates of the trestles with a void existing between the trestles when under the load. Each of the trestles further comprises the top plate, at least one adjustor, at least one motor, and electronics. At least one adjustor includes a height adjustor that vertically adjusts a vertical position of the top plate within a range. The motor is configured to move the adjustor(s) within the range when activated. The electronics include a wireless transceiver configured to receive wireless signals from a support controller. The electronics process the wireless signals in real time to activate the at least one motor to ultimately perform adjustments within the range consistent with instructions of the wireless signals. The trestles cooperatively and concurrently respond to the wireless signals from the support controller to raise and lower at least the height of the remotely adjustable scaffold and the supported materials.

One aspect of the disclosure is for a remote control jobsite material supporting system. The system includes an adjustable support and a support controller. The adjustable support is configured to support material for cutting and to adjust a height of said supported material via inputs entered via the support controller. The adjustable support includes a set of collapsable legs, each being configured to contact a ground surface when not collapsed. The adjustable support also includes a top plate, a vertical height adjustor, at least one motor, and a transceiver. The top plate supports a load of the material, which keeps the material suspended off the ground. It also provides a void through which cutting occurs. The vertical height adjustor is configured to change the vertical position of the top plate. That is, the adjustor includes components that interact to raise/lower supported material. The one or more motors supply motive power to move the vertical height adjustor (and related components), which ultimately changes the vertical position of the top plate. The transceiver is configured to receive wireless signals, which are configured to be interpreted by electronics of the adjustable support to turn the at least one motor on and off to ultimately change the vertical position of the top plate. The support controller is configured to receive inputs from a user to raise and lower the supported material, which results in corresponding signals being generated and being wirelessly conveyed to the transceiver.

Another aspect of the disclosure is for an adjustable trestle that is a portable structure configured to be rapidly repositioned by a human within a work site. The trestle is physically, mechanically, and electronically independent of any other trestle, yet is configured to be cooperatively and concurrently controlled in conjunction with at least one additional instance of the adjustable trestle. The trestle is configured to support a load of the materials extending across a top plate of the trestle with a void existing between the trestle and any other surface when under the load, which allows the material under load to be cut with a cutting tool extending through the material and into the void. The trestle is configured to adjust a vertical and horizontal position of material under load by adjusting a position of the top plate which occurs responsive to signals received wirelessly from a support controller.

### BRIEF DESCRIPTION OF THE DRAWINGS

FIG. 1 shows a system having at least one adjustable support with a remote, wireless controller in accordance with embodiments of the disclosure.

FIG. 2A shows an adjustable support with vertical and horizonal adjustments in accordance with embodiments of the disclosure.

FIG. 2B shows an embodiment of an adjustable support (e.g., metal/plastic sawhorse) consistent with FIG. 1.

FIG. 2C shows an embodiment of an adjustable support (e.g., single post support with angle adjustment) consistent with FIG. 1.

FIG. 2D shows an embodiment of an adjustable support (e.g., wooden sawhorse) consistent with FIG. 1.

FIG. 2E shows an embodiment of two adjustable supports forming a scaffold consistent with FIG. 1.

FIG. 2F shows an embodiment of two adjustable supports connected through lengths of two-by-fours inserted into sawhorse slots consistent with FIG. 1.

FIG. 3 shows a model computing device utilized with the adjustable support in accordance with embodiments of the disclosure.

### DESCRIPTION OF THE PREFERRED EMBODIMENTS

The preferred embodiments of the present invention will now be described with reference to the drawings. Identical elements in the various figures may be identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

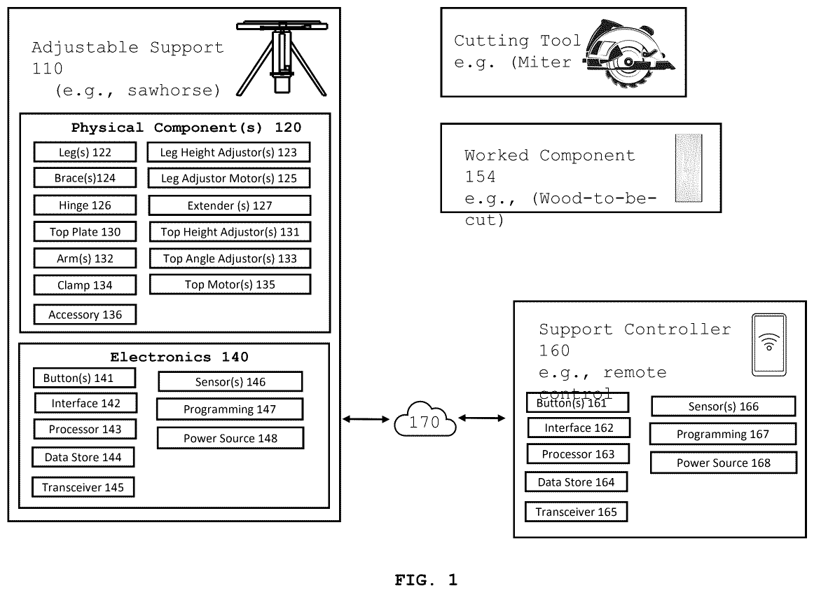

Referring to FIG. 1A, an adjustable support 110 (e.g., sawhorse or stand) having a support controller 160 (e.g., remote control) able to wirelessly adjust a position of the support 110. Generally, the adjustable support 110 bears a load of a worked component 154 (e.g., wood-to-be-cut) that is cut by cutting tool 150 (e.g., circular or miter saw).

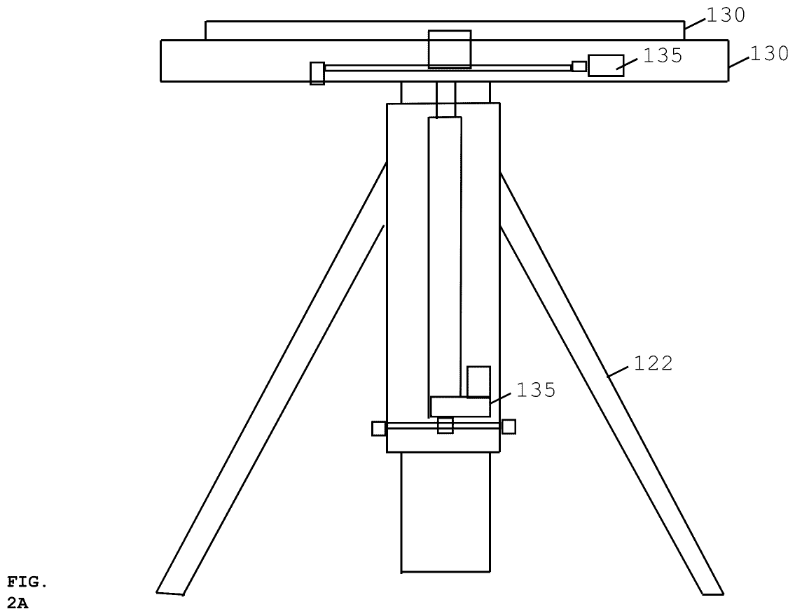

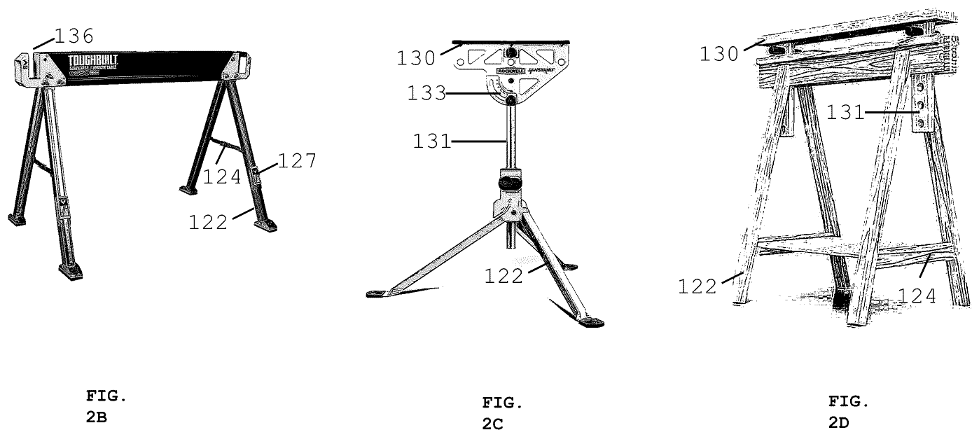

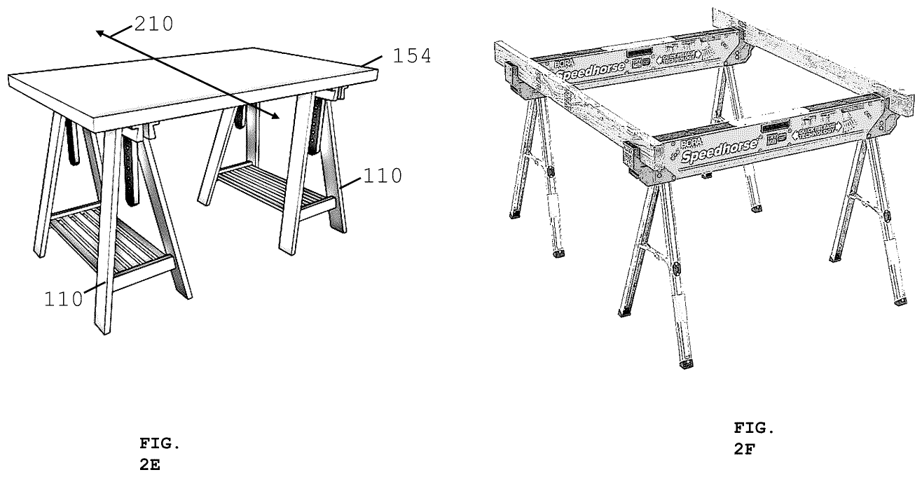

With reference to FIG. 2A, an adjustable support stand 110 is shown that has an arrangement divergent from a traditional sawhorse. In one embodiment, the arrangements of FIG. 2A are particularly useful to support, lift, lower, and move side-to-side lumber and other materials supported on one side (terminal end), where a cutting end can be a stationary (or moderately stationary) work station, such as one including a miter saw. Thus, a worker (positioned at the workstation/cutting side, can use controller 160 to make large or micro adjustments by remote without having to leave the saw or workstation.

The legs 122 can be adjustable and may collapse for storage. Two different “rails, which move horizontally as well as vertically can constitute the top plate 130. In one embodiment, these can be angled (133) and may have horizontal (top plate) extenders for enhanced support. As shown, a ball screw (123) is turned by a motor 135 to adjust a horizontal position (as well as the angle or spacing between top rails) of the top plate, which supports a load (154). These adjustments also move the load (154), which is important to understand. A second ball screw 120 can be connected to a motor 135, which is connected to a vertical shaft, which telescopes up/down. This raises/lowers the top plate 130. Appreciably, one (or more) of the supports 110 can be used to manipulate loads remotely, such as from a workstation/worktable/miter saw. For example, an especially heavy load can be supported at a terminal end by a first support 110 and in a middle by a second support 110 in one embodiment, where the opposing end is manually manipulated by a worker, who may concurrently use controller 160. In embodiments, two or more supports 110 may need to be moved concurrently to prevent loads from shifting.

To elaborate, embodiments of the present invention solve real-world experienced and unresolved problems by providing a stand, trestle, scaffold (e.g., adjustable support 110) that can be adjusted by remote control (e.g., controller 160) while a load (resulting from a force of gravity applied while supporting component 154) is applied. The stand/support (110) can lift, lower, and move material left or right. In embodiments, the stand/support (110) can be angled.

One aspect of the disclosure is for a remote-controlled apparatus (110) used to support, lift, lower, and move side to side lumber and other materials in a variety of applications including but not limited to cutting, assembling, or installing. The apparatus (110) can include multiple (often four) folding adjustable legs 122, a telescopic vertical main shaft, and a horizontal top rail (see FIG. 2A, for example). Inside the main shaft is an electronic actuator to provide vertical linear movement. The top rail is equipped with a motor and ball screw (or other adjustor) to provide horizontal linear movement.

In one embodiment (see FIG. 2E) two opposing supports 110 can bear a load of and raise material or component 154, which can be planar and positioned at approximately waist height and parallel to a ground surface. A cutting tool 150 is placed between two supports 110 and is able to be cut along a length 210 to separate component 154 into two pieces. In one embodiment, two different supports 110 (see FIG. 2E) must be controlled concurrently via a single wireless controller 160. That is, if a controller 160 raised a right hand side (RHS) support 110 of FIG. 2E without also raising the left hand side (LHS) support 110, the component 154 under load can slide and fall, which is a dangerous situation.

This disclosure emphasizes that the disclosed system inclusive of support 110 and a remote controller 160 has non-obvious significance discovered by the inventor during the course of this innovation. No viable alternative is believed to exist and the wireless nature has a nonobvious significance; as a wired controller and/or one connected to the support 110 in a conventional fashion results in significant operational concerns.

### Remote Control While Under Load Essential in Context

Using FIG. 2E as a reference, cutting component 154 in two, requires cut ends to be supported (typically by hand) to prevent them from falling (due to gravity once the component has been cut). Although conventional sawhorses have some manual adjustments (such as being able to telescope legs in/out, these adjustments cannot generally be made while bearing a load. Further, as a planar component, such as plywood is expected to be placed above support 110 or across two supports 110, a horizontal barrier parallel with a ground surface often exists that separates a worker from a sawhorse or an adjustable support 110 (and its components). Thus, a user would have to crawl beneath the horizontal plane of a material under load (component 155) to attempt to manually telescope/retract a leg or other adjustable component of support 110 when in use under load, which is dangerous. Applicants emphasize that supports 110 are designed for workplace use and are portable, temporary fixtures of construction worksites intended to be easily moved and to be dynamically, easily repositioned. Thus, one cannot simply add “additional” components to the support system, without suffering from a reduction of portability/mobility, which inherently degrades the value. In simple terms, any modifications requiring impeding portability, versatility, or appreciably adding to set-up time significantly decrease the usage value and thus would not be viable in context.

Conventional “adjustable sawhorses” as a practical matter must be positioned and adjusted prior to bearing a load. Construction workers will often be rushed and will often not be overtly careful in adjusting each aspect of a sawhorse between cuts. Thus, semi-level and/or unstable surfaces (formed across sawhorses improperly adjusted) is common. Stated simply, it is highly advantageous to be able to quickly adjust a set of sawhorses bearing a load, yet this is unpractical with manually adjustable sawhorses as they exist in the art.

A sawhorse attached control or button panel (hypothetically possible), or other adjusting mechanism, positioned on support 110 would necessarily be obstructed by component 154 when in use. That is, a worker would need to “crawl” under a portion of a supported component 154 to utilize such a mechanism (e.g., a button box or the like connected to the sawhorse), which is unwieldy and dangerous. Loads (154) applied across supports 110 can be quite heavy and are subject to “falling” when cut. Further, cutting tool 150 passes through a plane of the worked component 154, and can cut a body part of a worker positioned beneath the component 154. Thus, severe worker safety concerns (being cut by tool 150), ergonomic and safety concerns (e.g., workers having to crawl on a construction site's ground often laden with sawdust and sharp objects like nails) and practical concerns result in the inclusion of adjustment controls on a surface of support 110 being unviable in context.

Alternatively, a wired controller connected to support 110 could theoretically permit button manipulations without obstruction of component 150. However, such a wired component will necessarily physically extend proximate to the surface of component 150, which is being cut by tool 150. Hence, any attempt to utilize a physical wire to improve worker safety/ergonomics would result in a foreseeable risk of such a wire being inadvertently cut, while the support 110 is in use. Thus, the inclusion and use of wireless controller 160 is particularly significant within the unique constraints of the intended and actual use of support 110. Outside this disclosure, use of a wireless controller for an adjustable sawhorse or similar support 110 is not known to be contemplated. Thus, the system of adjustable support 110 and support controller 160 are believed to resolve a long felt, yet unsatisfied need in an innovative way, which has not been obvious despite this need persisting in the field for an extended time.

Having provided context dependent information regarding the support system and turning back to FIG. 1A, the adjustable support 110 includes physical components 120 and electronics 140. The physical components 120 can vary from configuration-to-configuration, but may include legs 122, a leg height adjustor 123, a leg adjustor motor 125, a brace 124, hinge 126, top plate 130, a top height adjustor 131, a top angle adjustor 133, a top motor 135, a top extender 127, arms 132, a clamp 134, accessory 136, and the like.

Various materials and styles may be used for the support 110. For example, FIG. 2B shows a support with four legs 122, each having a sliding or telescoping height adjustor 123 connected to a motor 125. A brace 124 extends between each pair of legs 122, which are foldable for storage. A notable accessory 136 is a wood plank (2×4) indentation, which can be used for stabilization and/or creating a parallel plane of planks between supports when supports are paired, as shown by FIG. 2F.

Unlike the metal/plastic support 110 of FIG. 2B, a wooden support 110 is shown FIG. 2D. As shown, the legs 122 of FIG. 2D are not extendible, but the top plate 130 is configured to be adjusted (131) vertically. The motor(s) 125 and/or 135 and actuation mechanisms are not illustrated in FIG. 2D (yet are present) in order to visually highlight the differences with a telescoping top plate 130 of an embodiment.

A simplified drawing of a three legged 122 configuration of support 110 is shown by FIG. 2C. This embodiment includes a single vertically extending rod functioning as an extender 131 altering a vertical position of top plate 130. Additionally, an angle adjustor 133 is illustrated, which allows various angles in a range of approximately 45 degrees to be applied to the top plate 130. This arrangement will generally not be used (and at least not for gross angle adjustments) when supports 110 are paired to create a scaffolding. However, it can be quite useful when a single support 110 is used to support a load. In such an embodiment, component 154 under load may be secured in a position using a clamp 134 or brace 124 (not shown). A more detailed configuration of support 110 is shown in FIG. 2A, which incorporates a majority of the physical components 120.

Turning back to FIG. 1A, cutting tool 150 can include any tool capable of being applied to a top surface of the worked component 154 to extend through component 154 and emerge from a bottom of component 154 when supported (110). In simple terms, tool 150 cuts through component 154. In embodiments, tool 150 can include a circular saw, a handsaw, a jigsaw, a table saw, a miter saw, a table saw (stationary or handheld), a reciprocating saw, a band saw (stationary or handheld), and the like. In embodiments, stationary saws can be directly coupled to support 110 and/or to an accessory 136 coupled thereto. Handheld saws (powered or not) are utilized in other embodiments.

The worked component 154 is any material able to be cut by tool 150 and able to be supported via support 110. Worked component 154 includes plywood, lumber, foam board, installation, sheetrock, drywall, laminate, vinyl (siding and plank flooring), tile, and the like. In embodiment, overly flexible materials lacking rigidity to be self-supportin across a void between opposing sawhorses (110) may be cut anyways using a layer of cheap underlying support (like a foam or cardboard) in conjunction with the flexible material only during a cutting process, where the cheap support material is discarded after cutting.

The support controller 160 can be any electronic device able to receive and interpret human provided input, to wirelessly convey signals (across network 170) responsive to the input, and to be received and interpreted by electronics 140 of the supports 110 to selectively control an actuator (motor 125, 135) adjusting one or more of the physical components 120, such as adjusting a top plate height 130 relative to a ground surface and/or adjusting an angle of the top plate 130 relative to an angle of the ground surface.

Wireless signals conveyed from controller 140 to electronics 140 can be analog or digital and may utilize different frequencies of the electromagnetic (EM) spectrum, including infrared and radio frequencies. In embodiments, the network 170 can be an internet, a local area network, or a personal area network. Packet-based data signals may be used in embodiments. Power saving protocols, such as BLUETOOTH ones may be used in embodiments.

In some embodiments, communications between electronics 140 and controller 160 can be bidirectional. For example, one or more sensors 146 may read information relative to a position of support 110 components 120 and provide that information to support controller 160. In another example, sensors 146 data from multiple supports 110 can be fed into controller 160 (or an intermediary processing component connected to network 170) to control multiple supports 110 at once. Sensor data can indicate weight, level readings, and the like. Numerous microelectromechanical (MEM) sensors, including an accelerometer and motion detector can be useful for providing information to smoothly adjust support 110 under load conditions.

Various user interface(s) components exist for interface 162, including programmable (67) ones, touch screen interfaces, programmable buttons, dedicated buttons, and the like. Different modalities, such as voice control and audible messages, can be used that include visual, touch, audible, virtual (extended reality XR interface(s)), and the like are contemplated. Various user input/controlling options of interface 162 include, raising and lowering top plate 130, moving top plate right/left, angling top plate, moving individual legs 122 (or all legs 122), up/down, altering movement speed (of other controls), opening/closing clamps/braces (136) and the like. In one embodiment, an additional, independent interface 142 with buttons 141 for manual control may exist within the electronics 140 of support 110.

In embodiments, one or more controller 160 sensors 166 can be incorporated, such as a laser sight/level pointer, which works in cooperation with another sensor (146) in embodiments. Sensor feedback 146, 166 can be used to slow/stop adjustments when a load shifts significantly to ensure the material 154 does not fall unexpectedly.

In embodiments, a data store 144, 164 of electronics, controller 160, and/or a network 170 based support server can store information used by the system, which includes programmable presets. Programmable controls may, for example, be configured to a specific position/adjustment. For example, two different linked controllers 110 can be configured to be raised equivalently and the same time and pace. In another embodiment (see FIG. 2A), a support 110 can be programmed to be raised (131) and tilted (133) concurrently so that an endpoint supporting a 2X4 or other material (154) is elevated or dropped while being worked at an angle by a fixed cutting tool 150 worked by a human stationed in a stationary position. In one embodiment, a roller accessory (136) can be positioned on a top plate 130 and/or can even be motorized (to move the component 154 in a direction by moving the rollers), which can be part of a programmatic setting (such as move height 133 to be level with a fixed surface, release a clamp 134, and actuate the roller slowly from a single button press (assuming this is a repetitive process for a given project). In short, projects requiring support 110 and cutting tool 150 are heavily varied, but often repetitive, and the inclusion of a saving setting can be beneficial as implemented herein. In embodiments, a setting “training” mode is enabled so that once begun a “macro” is created so that whatever steps are performed between the initiation and termination (of the macro) are saved and repeated when pressed in the future.

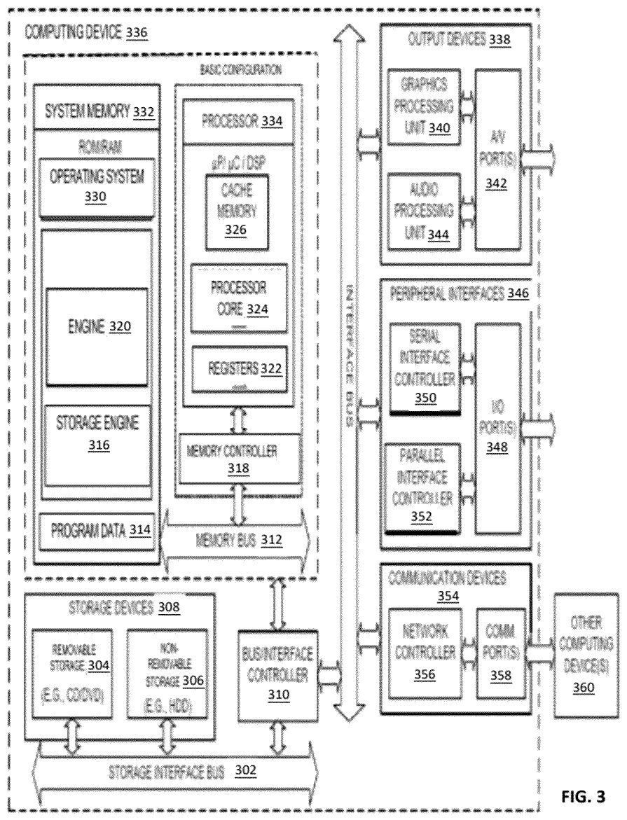

In embodiments, the support controller 160 can be a mobile phone, which runs on a mobile OS. An application running on this OS can provide controller 160 support as detailed herein. The electronics 140 of support 110 and control 160 may include a processor 143, 163, a transceiver 145, 165, and a power source 148 (see FIG. 3).

### Systems, Devices and Operating Systems

A basic configuration of a computing device is illustrated in FIG. 3 by those components within the inner dashed line. In the basic configuration of the computing device 336, the computing device 336 includes a processor 334 and a system memory 332. The terms “processor” and “central processing unit” or “CPU” are used interchangeably herein. In some examples, the computing device 336 may include one or more processors and the system memory 332. A memory bus 312 is used for communicating between the one or more processors 334 and the system memory 332. With reference to FIG. 2A, magazine 220 can be considered computing device 336; microprocessor 246 can be considered processor 334; memory 248 equates to memory 332, and the like. Reactive target 204 and VR/XR system 206 are also able to be considered computing devices 336 or sets thereof.

Referring back to FIG. 3, depending on the desired configuration, the processor 334 may be of any type, including, but not limited to, a microprocessor (μP), a microcontroller (μC), and a digital signal processor (DSP), or any combination thereof. In examples, the microprocessor may be AMD's ATHLON, DURON and/or OPTERON; ARM's application, embedded and secure processors; IBM and/or MOTOROLA's DRAGONBALL and POWERPC; IBM's and SONY's Cell processor; INTEL′S CELERON, CORE (2) DUO, ITANIUM, PENTIUM, XEON, and/or XSCALE; and/or the like processor(s).

Further, the processor 334 may include one more levels of caching, such as a level cache memory 326, a processor core 324, and registers 322, among other examples. The processor core 324 may include an arithmetic logic unit (ALU), a floating point unit (FPU), and/or a digital signal processing core (DSP Core), or any combination thereof. A memory controller 318 may be used with the processor 334, or, in some implementations, the memory controller 318 may be an internal part of the memory controller 318.

Depending on the desired configuration, the system memory 332 may be of any type, including, but not limited to, volatile memory (such as RAM), and/or non-volatile memory (such as ROM, flash memory, etc.), or any combination thereof. The system memory 332 includes an operating system 330, one or more engines, such as an engine 320, and program data 314. In some embodiments, the engine 320 may be an application, a software program, a service, or a software platform, as described infra. The system memory 332 may also include a storage engine 316 that may store any information of data disclosed herein.

The operating system 330 may be a highly fault tolerant, scalable, and secure system such as: APPLE MACINTOSH OS X (Server); AT&T PLAN 9; BE OS; UNIX and UNIX-like system distributions (such as AT&T's UNIX; BERKLEY SOFTWARE DISTRIBUTION (BSD) variations such as FREEBSD, NETBSD, OPENBSD, and/or the like; Linux distributions such as RED HAT, UBUNTU, and/or the like); and/or the like operating systems. However, more limited and/or less secure operating systems also may be employed such as APPLE MACINTOSH OS, IBM OS/2, MICROSOFT DOS, MICROSOFT WINDOWS 2000/2003/3.1/95/98/CE/MILLENNIUM/NT/VISTA/XP (Server), PALM OS, and/or the like. The operating system 330 may be one specifically optimized to be run on a mobile computing device (e.g., one configuration for device 220 FIG. 1A), such as iOS, ANDROID, WINDOWS Phone, TIZEN, SYMBIAN, and/or the like.

As explained supra, the GUI may provide a baseline and means of accessing and displaying information graphically to users. The GUI may include APPLE MACINTOSH Operating System's AQUA, IBM's OS/2, Microsoft's WINDOWS 2000/2003/3.1/95/98/CE/MILLENNIUM/NT/XP/Vista/7 (i.e., AERO), UNIX'S X-Windows (e.g., which may include additional UNIX graphic interface libraries and layers such as K DESKTOP ENVIRONMENT (KDE), MYTHTV and GNU Network Object Model Environment (GNOME)), web interface libraries (e.g., ActiveX, AJAX, (D) HTML, FLASH, JAVA, JAVASCRIPT, etc. interface libraries such as, but not limited to, DOJO, JQUERY (UI), MOOTOOLS, PROTOTYPE, SCRIPT.ACULO.US, SWFOBJECT, or YAHOO! User Interface, any of which may be used.

Additionally, a web browser component (not shown) is a stored program component that is executed by the CPU. The web browser may be a conventional hypertext viewing application such as MICROSOFT INTERNET EXPLORER, EDGE, CHROME, FIREFOX, or NETSCAPE NAVIGATOR. SECURE WEB browsing may be supplied with 128 bit (or greater) encryption by way of HTTPS, SSL, and/or the like. Web browsers allowing for the execution of program components through facilities such as ACTIVEX, AJAX, (D) HTML, FLASH, JAVA, JAVASCRIPT, web browser plug-in APIs (e.g., FIREFOX, SAFARI Plug-in, and/or the like APIs), and/or the like. Web browsers and like information access tools may be integrated into PDAs, cellular telephones, and/or other mobile devices.

A web browser may communicate to and/or with other components in a component collection, including itself, and/or facilities of the like. Most frequently, the web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a web browser and an information server, a combined application may be developed to perform similar functions of both. The combined application would similarly affect the obtaining and the provision of information to users, user agents, and/or the like from the enabled nodes of the present invention.

Moreover, the computing device 336 may have additional features or functionality, and additional interfaces to facilitate communications between the basic configuration and any desired devices and interfaces. For example, a bus/interface controller is used to facilitate communications between the basic configuration and data storage devices via a storage interface bus 302. The data storage devices may be one or more removable storage devices, one or more non-removable storage devices, or a combination thereof. Examples of the one or more removable storage devices and the one or more non-removable storage devices include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus facilitates communication from various interface devices (e.g., one or more output devices 338, one or more peripheral interfaces 346, and one or more communication devices 354) to the basic configuration via the bus/interface controller 310. Some of the one or more output devices 338 include a graphics processing unit 340 and an audio processing unit 344, which are configured to communicate to various external devices, such as a display or speakers, via one or more A/V ports 342.

The one or more peripheral interfaces 346 may include a serial interface controller 350 or a parallel interface controller 352, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 348.

Further, the one or more communication devices 354 may include a network controller 356, which is arranged to facilitate communication with one or more other computing devices 360 over a network 202 communication link via one or more communication ports 358. The one or more other computing devices 360 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 332, the one or more removable storage devices 304, and the one or more non-removable storage devices 306 are examples of the computer-readable storage media. The computer-readable storage media is a tangible device that can retain and store instructions (e.g., program code) for use by an instruction execution device (e.g., the computing device 336). Any such, computer storage media is part of the computing device 336.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer-readable instructions are provided to the processor 334 of a general purpose computer, special purpose computer, or other programmable data processing apparatus (e.g., the computing device 336) to produce a machine, such that the instructions, which execute via the processor 334 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 336), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A remote control jobsite material supporting system comprising:
an adjustable support configured to support material for cutting and to adjust a height of said supported material via inputs entered via a wirelessly connected support controller, said adjustable support comprising:
a plurality of collapsable legs, each being configured to contact a ground surface when not collapsed;
a top plate configured to support a load of the material;
a vertical height adjustor configured to change a vertical position of the top plate;
at least one motor configured to supply motive power to move the vertical height adjustor, which changes the vertical position of the top plate;
a transceiver configured to receive wireless signals, which are configured to be interpreted by electronics of the adjustable support to turn the at least one motor on and off to ultimately change the vertical position of the top plate; and
a support controller configured to receive inputs from a user to raise and lower the supported material, which results in corresponding signals being generated and being wirelessly conveyed to the transceiver.

2. The system of claim 1, wherein the adjustable support is configured to support a load of the supported material on one end while an opposing end of the supported material is positioned within a fixed position workstation comprising a miter saw, wherein the support controller is configured to accept inputs form a worker utilizing the miter saw at the fixed position workstation to effectuate micro and macro adjustments of the material in support of cutting a portion of the opposing end at a desired saw angle via the miter saw as determined by the worker, whereby a single human, the worker, is able to precisely control cutting of a supported material via a fixed position workstation with adjustments being made to a position of the one end.

3. The system of claim 1, which comprises a plurality of adjustable supports, wherein the support controller concurrently controls the plurality of adjustable supports such that each of the plurality of adjustable supports are adjusted vertically in a corresponding fashion responsive to a single input via the controller.

4. The system of claim 3, wherein cach of the plurality of adjustable supports is a sawhorse, wherein a first of the plurality supports a right end of the material, wherein a second of the plurality supports a left end of the material, wherein the plurality of sawhorses form a scaffold for the material.

5. The system of claim 1, wherein the support controller is a mobile phone having a touch screen and a mobile operating system upon which mobile applications run, wherein the mobile application receives the inputs from the user that enters the inputs by touching a screen of the mobile phone running a user interface for the mobile application, wherein the signals.are wirelessly conveyed over a BLUETOOTH network.

6. The system of claim 1, wherein at least one of the adjustable support and the support controller comprise a memory which stores a sequence of user established custom adjustments to be made to the materials, said stored sequence being triggerable by the user via the support controller.

7. The system of claim 1, wherein the vertical adjustor comprises a rod connected to the motor, which rotates as the motor spins, wherein a spinning of the rod causes a vertical extender to be raised or lowered, which changes the vertical position of the top plate.

8. The system of claim 1, wherein at least one roller is positioned on the top plate, wherein the material rests upon the at that one roller.

9. The system of claim 1, wherein at least one clamp is attached to the top plate to secure a position of the material, wherein the support controller controls an opening and closing of the at least one clamp.

10. The system of claim 1, wherein the top plate is configured to be adjusted horizontally, which shifts a horizontal position of the supported material, wherein inputs via the support controller are for horizontal adjustments.

11. The system of claim 1, wherein the adjustable support is one of two adjustable trestles, which together form an adjustable scaffold, wherein each of the trestles is a portable structure configured to be rapidly repositioned by a human within a work site, wherein each of the trestles is physically, mechanically, and electronically independent of the other one of the trestles, wherein the trestles are configured to support a load of the materials extending across respective ones of the top plates of the trestles with a void existing between the trestles when under the load.

12. A remotely adjustable scaffold for supporting materials to be cut comprising:
a first adjustable trestle;
a second adjustable trestle, wherein in aggregate the first adjustable trestle and the second adjustable trestle are referred to as trestles, wherein each of the trestles is a portable structure configured to be rapidly repositioned by a human within a work site, wherein each of the trestles is physically, mechanically, and electronically independent of the other one of the trestles, wherein the trestles are configured to support a load of the materials extending across top plates of the trestles with a void existing between the trestles when under the load, wherein each of the trestles further comprises:
the top plate;
at least one adjustor, which comprises a height adjustor that vertically adjusts a vertical position of the top plate within a range;
at least one motor, which when activated is configured to move the at least one adjuster within the range;
electronics comprising:
a wireless transceiver configured to receive wireless signals form a support controller;
wherein said electronics process the wireless signals in real time to activate the at least one motor to ultimately perform adjustments within the range consistent with instructions of the wireless signals, wherein the trestles cooperatively and concurrently respond to the wireless signals from the support controller to raise and lower at least a height of the remotely adjustable scaffold and the supported materials.

13. The scaffold of claim 12, wherein each of the trestles is a sawhorse.

14. The scaffold of claim 12, wherein each of the trestles is a portable support comprising a plurality of collapsible legs.

15. The scaffold of claim 12, wherein the support controller is a smart phone running a downloadable application which is a remote control application for the trestles.

16. The scaffold of claim 15, wherein the adjustable scaffold is configured to be adjusted horizontally and vertically when under load via input from the support controller, wherein a speed of horizontal and vertical adjustments performed by the trestles is variable and is controlled by the support controller.

17. An adjustable trestle that is a portable structure configured to be rapidly repositioned by a human within a work site, wherein the trestle is physically, mechanically, and electronically independent of any other trestle, yet is configured to be cooperatively and concurrently controlled in conjunction with at least one additional instance of the adjustable trestle, wherein the trestle is configured to support a load of the materials extending across a top plate of the trestle with a void existing between the trestle and any other surface when under the load, which allows the material under load to be cut with a cutting tool extending through the material and into the void, wherein the trestle is configured to adjust a vertical and horizontal position of material under load by adjusting a position of the top plate which occurs responsive to signals received wirelessly from a support controller.

18. The adjustable trestle of claim 17, further comprising:
a plurality of legs;
a top height adjustor;
a top angle adjustor; and
a top motor.

19. The adjustable trestle of claim 17 further comprising electronics comprising:
a user interface;
a processor;
a data store;
a transceiver;
programming; and
a power source.

20. The adjustable trestle of claim 19, wherein the electronics further comprise:
at least one weight sensor for determining a weight of material supported by the adjustable trestle.
